(19) United States
(12) Patent Application Publication
(10) Pub. No.: US 2025/0263296 A1
(43) Pub. Date: Aug. 21, 2025

(54) PROCESS FOR PURIFYING HYDROGEN HALIDE SOLUTIONS CONTAINING ORGANIC IMPURITIES

(71) Applicant: ALBEMARLE CORPORATION, Charlotte, NC (US)

(72) Inventors: Jeffrey Todd APLIN, Zachary, LA (US); Thanikavelu MANIMARAN, Baton Rouge, LA (US); Keyur SHAH, Waxhaw, NC (US); Benjamin R. CAIRE, Baton Rouge, LA (US); Charles W. HAMILTON, Marvin, NC (US)

(21) Appl. No.: 18/292,383

(22) PCT Filed: Jul. 27, 2022
(86) PCT No.: PCT/US2022/038421

§ 371 Date: Jan. 26, 2024

Related U.S. Application Data
(60) Provisional application No. 63/203,531, filed on Jul. 27, 2021.

(51) Int. Cl. C01B 7/09; C01B 7/07; C01B 7/13

(52) U.S. Cl. CPC C01B 7/093; C01B 7/0725; C01B 7/135

(57) ABSTRACT

The disclosure relates to a novel plant process for purifying hydrogen halide solutions. The process includes halogenating the organic compounds, particularly phenolic compounds, in the hydrogen halide solution to precipitate the halogenated compounds. The halogenated compounds can be filter, the hydrogen halide solution further purified on an adsorbent bed, and the clean hydrogen halide solution can be recycled or used in other processes.

### TECHNICAL FIELD

The various embodiments of the disclosure relate generally to a process for removing organic impurities, particularly phenolic impurities, from a hydrogen halide solution. It is particularly useful for post-halogenation byproduct streams.

### BACKGROUND

Among industrial processes, halogen oxidations (or oxidative halogenations) of organic compounds produce a significant number of commercial products. For example, brominated flame retardants such as tetrabromobisphenol A (TBBPA) are prepared by a bromine oxidation of an organic substrate, e.g. bisphenol, to produce TBBPA. The products of that bromine oxidation include the valuable flame retardant, but also an aqueous byproduct stream which typically includes HBr and impurities. Chlorine oxidations are also challenged by aqueous byproduct streams that must be addressed.

For an industrial process to be commercially competitive, the byproduct streams must be utilized or disposed in an economical method. This could include recycling the stream back into the process, diverting the stream into another process, or converting the stream into a separate commercial product. In the absence of these option, disposal may be necessary, but simply disposing of an industrial stream is both environmentally challenging and commercially ineffective because it wastes atom-value from the process. Thus, recycling the stream back into the process, diverting the stream into another process, or converting the stream into a separate commercial product are much preferred, but the impurity profile of that byproduct stream becomes a significant hurdle to overcome.

### BRIEF SUMMARY

The various embodiments of the disclosure relate generally to a process for treating an hydrogen halide stream having a phenolic residue.

An embodiment of the disclosure can be the process for treating the HX stream by oxidative halogenation, or treating the stream with a halogen, to halogenate the phenolic reside, producing a halogenated phenolic residue and a halogenated solution. The halogenated solution can be cooled and filtered to remove the halogenated phenolic residue from the halogenated solution to produce a partially purified HX stream. The process can include the further step of passing the partially purified HX stream across an adsorbent bed, producing a purified HX stream.

In some embodiments, the HX stream comprises an HCl stream, an HBr stream, an HI stream, or combinations thereof. In some embodiments, the HX stream comprises and HCl or HBr stream, or an HBr stream. The HX stream can be less than about 30 wt % HX, less than about 20 wt % HX, less than about 15 wt % HX or less than about 12 wt % HX.

In some embodiments, the HX stream can contain less than about 5 wt % phenolic residue, or less than about 3 wt % phenolic residue, or less than about 1 wt % phenolic residue.

In an embodiment, the HX stream, the partially purified HX stream, and the purified HX stream each comprises HBr.

In some embodiments, the oxidative halogenation is oxidative bromination, and the halogen in bromine.

In some embodiments, the oxidative halogenation is conducted at or above about 60° C.; at or above 80° C., or at or above 90° C.

In some embodiments, the reaction after oxidative halogenation is cooled to about 60° C. or less; or the reaction is cooled to about 40° C. or less. In some embodiments, the reaction is cooled to at least about 20° C. below the oxidative halogenation temperature.

In some embodiments, the ratio of halogen to phenolic residue is about 2:1 to 20:1 weight/weight; or the ratio of halogen to phenolic residue is about 8:1 to 12:1 weight/weight.

### DETAILED DESCRIPTION

Although preferred embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another embodiment includes from the one particular value and/or to the other particular value.

By “comprising” or “comprising” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The present disclosure developed as part of a plant process development program. Bromine oxidation (i.e., electrophilic substitution of bromine on an aromatic ring) of organic compounds produces hydrobromic acid, also known as hydrogen bromide, which must be utilized or disposed. However, the HBr stream contains numerous challenges. In particular, phenolic compounds from some process can complicate the utility and/or handling of a byproduct stream. Attempts to recover the bromine value from HBr are difficult due to the presence of organic impurities. One common option in any plant process is to recycle a stream into the process or related process, or to convert the stream to another product. However, recycling the untreated HBr stream can lead to generation of undesirable side products, which can lead to several complications, including but not limited to reducing the purity of a final product or precipitation of solids in and/or plugging of equipment.

As part of this plant process development program, a process has been developed that removed most of the organic impurities, especially phenolic impurities that dissolved in the HBr. It was discovered that the organic impurities in a TBBPA byproduct stream can be removed by reacting with bromine and/or chlorine, and converting the soluble impurities into much less soluble halogenated compounds, which can be precipitated. Removal of the solids by filtration gives HBr with substantially reduced levels of brominated impurities in solution. If needed, these brominated impurities can be decreased further by passing through a carbon or resin bed. The reaction with bromine can be carried out with 2-20 fold excess of bromine, preferably 10 fold to insure complete bromination of all the phenolic impurities. Higher bromination temperature is preferred to decrease the reaction time. A reaction temperature above 60° C., preferably above 90° C. is recommended. HBr solution purified by this method can be recycled to recover the bromine value or used for other applications. Notably, other processes that rely on halogen oxidations can be similarly purified using this method.

The present disclosure thus includes a process for purifying an HX stream that contains a phenolic residue. The process can include treating the HX stream by oxidative halogenation to halogenate the phenolic residue, which produces a halogenated phenolic residue and a halogenated solution. The halogenated solution can be cooled and filtered to remove the halogenated phenolic residue to produce a partially purified HX stream.

The HX stream can be described as a stream or a solution that contains a hydrohalide, also called a hydrogen halide. The term hydrohalide includes halogen acids, such as hydrochloric acid, hydrobromic acid, and hydroiodic acid, ie. HCl, HBr and HI. The compounds can also be described as hydrogen chloride, hydrogen bromine, and hydrogen iodide. Hydrohalide can be abbreviated as HX, where X is well-recognized as a halogen, i.e. Cl, Br, or I. A hydrohalide solution can comprise an HCl solution or HBr solution, or the hydrohalide solution can comprise an HBr solution. In some embodiments, the HX stream, the partially purified HX stream, and the purified HX stream can each independently comprise HBr. A hydrohalide solution or HX solution can comprise an aqueous solution. A hydrohalide solution or HX solution can comprise partially halogenated organic compounds, or can comprise organic compounds produced from a previous halogenation reaction.

The partially purified HX stream can be further processed. This processing can include passing the partially purified HX stream across an adsorbent bed, producing a purified HX stream. The adsorbent bed can be any adsorbent material used in industrial applications for acidic media that removes organic compounds from an aqueous stream. The adsorbent bed can include a carbon bed (e.g. an activated carbon bed) or a neutral resin bed such as a polystyrenic bed, a polydivinylbenzene bed or other polyaromatic resins.

The HX stream can generally contain less than about 5 wt % phenolic residue, less than about 1 wt % phenolic residue, or less than about 0.5 wt % phenolic residue. The phenolic residue can comprise an aromatic structure or pseudo-aromatic structure (such as a quinone moiety) that is susceptible electrophilic substitution by a halogen. The phenolic residue can include mono-bromophenols, di-bromophenols, tri-bromophenols and other phenolic and/or aromatic or pseudo-aromatic products. The phenolic residue can be a byproduct of the bromination of bisphenol A (IUPAC Name: 4,4′-(Propane-2,2-diyl)diphenol).

The HX stream can be less than about 50 wt % HX, less than about 40 wt % HX, or less than about 30 wt % HX. The process can be used on a HX stream that has been depleted or diluted due to a previous chemical process. Thus, the HX stream preferably can be less than about 20 wt % HX, less than about 15 wt % HX, or less than about 12 wt % HX.

Oxidative halogenation of the initial HX stream can be conducted at or above any temperature at which the electrophilic substitution can occur. The oxidative halogenation can be conducted at or above 25° C., at or above 60° C., at or above 70° C., at or above 80° C., or at or above 90° C. The oxidative halogenation can be conducted at higher temperatures, but is generally limited by pressure of the reaction medium. The oxidative halogenation can be conducted as high as 200° C. in specialized equipment, but higher temperatures would be generally considered unsafe.

Oxidative halogenation of the initial HX stream can be conducted with any halogen that can undergo electrophilic substitution on the phenolic residue. Oxidative halogenation, or halogen oxidation, generally means treating the solution with a halogen at a temperature such that the organic material in the solution is halogenated, producing a halocarbon bond and a hydrogen halide. The oxidative halogenation can be conducted with bromine (e.g. oxidative bromination) or with chlorine (e.g. oxidative chlorination). The oxidative halogenation can also be conducted with a combination of chlorine and bromine. The oxidative halogenation can be conducted with a halogen that can be added to the HX stream, or can be conducted with a halogen that can be generated in situ, such as for example the conversion of HBr to bromine by addition of chlorine, or conversion of HBr to bromine by addition of hydrogen peroxide. The halogen in the HX solution does not need to be the same as the halogen in the oxidative halogenation. In one embodiment the HX can be HBr and the halogen source can be bromine. In another embodiment the HX can be HBr and the halogen source can be chlorine, during which a portion of the chlorine reacts with the HBr to produce bromine and HCl, and the oxidation halogenation can be a mixture of chlorination and bromination. Preferably, the oxidative halogenation is oxidative bromination.

Oxidative halogenation of the initial HX stream can be conducted at a ratio of halogen to phenolic residue that effectively halogenates the phenolic residue. The ratio of halogen to phenolic reside can be about 2:1 to about 20:1 weight/weight, preferably about 8:1 to about 12:1 weight/weight.

After oxidative halogenation the halogenated solution can be cooled and then filtered. The halogenated solution can be cooled by at least about 10° C. below the temperature of the halogenation, or at least about 20° C. below the temperature of the halogenation, or at least about 30° C. below the temperature of the halogenation. The halogenated solution can be cooled to below 60° C., below about 50° C., or below about 40° C. Cooling can be accomplished by any technique used in a manufacturing process. In one embodiment, the cooling can be achieved by stripping off the residual halogen, such as by removing the residual bromine from the halogenated solution.

The partially purified HX stream and the purified HX stream can be used for other process reactions. For example, a partially purified HBr stream can be subjected to chlorination to produce bromine, which can be stripped from the solution and used in other bromination reactions, thereby recovering valuable bromine value. Similarly, a purified HX stream can be treated with chlorine to generate bromine.

An embodiment of the disclosure can be a process for purifying an HX stream containing a less than about 1 wt % phenolic residue, where the HX stream of about 15 wt % HX or less is treated with bromine or chlorine as the halogen at greater than 60° C. to halogenate the phenolic residue and produce a halogenated solution. The halogenated solution can be cooled to less than 60° C. and filtered to produce a partially purified HX stream. The partially purified HX stream can be further processed by passing it across an adsorbent bed.

An embodiment of the disclosure can be a process for purifying an HBr stream containing about 1 wt % or less phenolic residue, where the HBr stream of about 15 wt % HBr or less is treated with bromine as the halogen at greater than 60° C. to brominate the phenolic residue and produce a halogenated solution. The halogenated solution can be cooled to less than 60° C. and filtered to produce a partially purified HBr stream. The partially purified HBr stream can be further processed by passing it across an adsorbent bed.

An embodiment of the disclosure can be a process for purifying an HBr stream containing about 1 wt % or less phenolic residue, where the HBr stream of about 15 wt % HBr or less is treated with chlorine as the halogen at about 80° C. or greater to halogenate the phenolic residue and produce a halogenated solution. The halogenated solution can be cooled to about 60° C. or lower and filtered to produce a partially purified HX stream. The partially purified HX stream can be further processed by passing it across an adsorbent bed.

An embodiment of the disclosure can be a process for purifying an HBr stream containing about 1 wt % or less phenolic residue, where the HBr stream of about 15 wt % HBr or less is treated with bromine as the halogen at about 90° C. or greater to halogenate the phenolic residue and produce a halogenated solution. The halogenated solution can be cooled to about 60° C. or lower and filtered to produce a partially purified HBr stream. The partially purified HBr stream can be further processed by passing it across an adsorbent bed.

An embodiment of the disclosure can be a process for purifying an HBr stream containing about 1 wt % or less phenolic residue, where the HBr stream of about 15 wt % HBr or less is treated with bromine as the halogen at about 90° C. or greater to halogenate the phenolic residue and produce a halogenated solution. The halogenated solution can be cooled to about 40° C. or lower and filtered to produce a partially purified HBr stream. The partially purified HBr stream can be further processed by passing it across an adsorbent bed.

### EXAMPLES

### Example 1

A 3-necked 20 L reactor was set-up with a mechanical stirrer, a condenser and a thermowell. A process waste stream of about 10% HBr solution containing 306 ppm of phenolic impurities was used. A liquid chromatographic (LC) method was used for the measurement of the phenolic impurities. The HBr solution (16 kg) was charged to the reactor and agitated. It was heated to 95° C. with an electric mantle. When the temperature of the solution was above 50° C., 160 g of bromine was added and the heating was continued. After heating the mixture at 95° C. for 30 minutes, heating was turned off and the condenser was changed from reflux to distil. A vacuum pump was connected through two ice-cold traps containing dilute sodium sulfite solution. The mixture was gradually cooled to 60° C. by stripping off unreacted bromine and some water under vacuum. It was then allowed to cool to ambient at atmospheric pressure. It was then filtered using a medium fritted glass funnel to remove the precipitated solids. LC analysis of the filtered HBr solution showed only 26 ppm of phenolic impurities. Passing it through a column of styrenic resin resulted in 0 ppm of phenolic impurities in the HBr solution by LC analysis.

### Example 2

A 500 mL thick walled glass reactor with ace fittings was set up with a thermowell, a monometer and Teflon overhead with a stopcock connected to a receiving flask through a condenser. The receiving flask was connected to a vacuum line through another condenser and a trap. The reactor was charged with 300 g of a waste stream HBr containing −500 ppm of phenolic impurities. While magnetically stirring, it was heated rapidly with an electric mantle. When the temperature of the mixture reached 50° C., 3 g of bromine was added and the reactor was sealed. In about 15 minutes, the temperature of the mixture reached 120° C. and showed a reactor pressure of −25 psi. After stirring the mixture at this temperature for 25 minutes, the electric mantle was lowered and the pressure was released by carefully opening the overhead stopcock. The liquid distilling over was collected in the receiver. Vacuum was applied slowly to bring down the temperature of the mixture to 60° C.; typically it required a vacuum of 120-130 mm of Hg to get 60° C. The mixture was filtered at 60° C. and the hot HBr solution contained only 63 ppm of phenolic impurities.

### Example 3

800 g HBr samples (3-1A and 3-2A) were each treated with 80 g bromine (i.e. 10 wt %), heated to 55° C. and 80° C. respectively, and held for 30 minutes. The mixtures were filtered hot at the end of their hold times and sampled for GC analysis. Results are shown in Table 1.

The resulting solutions were allowed to stand for about 4 hours to cool to room temperature. The solutions were filtered again before proceeding. A 400 g portion of each mixture (3-1B and 3-2B) was then subjected to chlorination at 80° C. to look for the formation of any additional solids.

In a similar manner, two solutions of HBr (3-3 and 3-4) were treated with 1% wt. bromine, heated to 55° C. and 80° C. and held for 30 minutes, filtered hot, and sampled for GC analysis, and then cooled to room temperature and filtered again.

TABLE 1

| Sample No. | 3-1A | 3-1B | 3-2A | 3-2B | 3-3 | 3-4 |
|---|---|---|---|---|---|---|
| Halogen | Br2 | Cl2 | Br2 | Cl2 | Br2 | Br2 |
| Temperature | 55 | 80 | 80 | 80 | 55 | 80 |
| % Halogen | 10 | 100 | 10 | 100 | 1 | 1 |
| Phenol | — | — | 0 | 0 | 0 | 1 |
| Br1-Phenol | — | — | 0 | 0 | 0 | 0 |
| Br2-Phenol | — | — | 0 | 0 | 1 | 0 |
| Tribromophenol (ppm) | — | — | 8 | 0 | 35 | 0 |
| TBBPA (ppm) | — | — | 18 | 0 | 0 | 0 |
| Unknown Phenolics | — | — | 68 | 25 | 47 | 48 |
| Total Phenolics (ppm) | — | — | 94 | 25 | 82 | 49 |
| Filter Hot (g solids/kg | 0.262 | 0.045 | 0.418 | 0.019 | 0 | 0.020 |
| solution) | | | | | | |
| Filter after cooling to | 0.082 | — | 0.010 | — | 0.048 | 0.067 |
| room temp (g solids/kg | | | | | | |
| solution) | | | | | | |

### Example 4

An HBr sample was filtered to remove solids and sampled for analysis (4-0)

For 4-1A, 3083 g of the HBr sample was charged to a 5 L flask and heated to 80° C. About 1 wt % (30 g) of bromine was carefully added subsurface. The solution was mixed with a large stir bar for about 3 hours. The mixture was then filtered while still hot and the isolated solids washed with DI water. The hot solution was then split into 3 equal portions. One portion (4-1B) was left as is and allowed to stand overnight. The second portion (4-1C) was treated with just enough solid sodium sulfite to react away the bromine, sampled for analysis and allowed to stand overnight. The third portion (4-1D), 996 g, was charged to a 1 L flask and heated to 80° C., and 33 g of chlorine (enough to convert at least 75% of the HBr value) was added over about 5 minutes. The reaction was stirred for 30 minutes and filtered hot.

For Sample 4-2, 950 g of the HBr sample was charged to a 1 L flask and heated to 80° C. followed by the addition of 5 g of bromine. The mixture was stirred for 3 hours and filtered hot then sampled for analysis.

Sample 4-3 was treated exactly the same as Sample 4-2, with the exception that it was heated to 95° C.

TABLE 2

| Sample Id | 4-0 | 4-1A | 4-1B | 4-1C | 4-1D | 4-2 | 4-3 |
|---|---|---|---|---|---|---|---|
| Oxidant | — | Br2 | Br2 | Br2 | Cl2 | Br2 | Br2 |
| Wt % oxidant | — | 1 | 1 | 0 | 75 | 0.5 | 0.5 |
| Temperature ° C. | — | 80 | 25 | 25 | 80 | 80 | 95 |
| Time (min) | 0 | 180 | 1440 | 1440 | 30 | 180 | 180 |
| Br— | 8.05 | | | — | — | — | — |
| Cl— | 0.31 | | | — | — | — | — |
| APHA Color | 446 | | | 28 | 23 | 34 | 23 |
| Phenol | 0 | | | 0 | 0 | 0 | 0 |
| Br1-Phenol | 0 | | | 0 | 0 | 0 | 0 |
| Br2-Phenol | 0 | | | 0 | 0 | 0 | 0 |
| Tribromophenol | 10 | | | 10 | 0 | 16 | 12 |
| (ppm) | | | | | | | |
| TBBPA (ppm) | 22 | | | 0 | 0 | 27 | 0 |
| Unknown | 155 | | | 26 | 15 | 40 | 55 |
| Phenolics | | | | | | | |
| Total Phenolics | 188 | | | 36 | 15 | 84 | 68 |
| (ppm) | | | | | | | |
| Filter Hot (g | — | 0.0824 | — | — | 0 | 0.0364 | 0.0261 |
| solids/kg | | | | | | | |
| solution) | | | | | | | |
| Filter after | — | — | 0.0033 | 0 | 0.0125 | 0.0111 | 0.0228 |
| cooling to room | | | | | | | |
| temp (g solids/kg | | | | | | | |
| solution) | | | | | | | |
| Solids formed | — | — | Yes | No | No | | |
| after 48 hours? | | | | | | | |

### Example 5

An HBr sample was filtered to remove solids and sampled for analysis (Sample 5-0). In Sample No. 5-1, 863.9 g of the HBr sample was charged to a 1 L 4-neck round bottom flask. The mixture was heated to about 30° C. and about 26 g of Cl₂ was added over about 15 minutes. The reaction temperature rose to about 40° C. during the addition. The mixture was sampled at 15 minutes hold time (the sample was filtered before analysis). The experiment was stopped at 30 minutes of hold time and the remaining mixture was filtered. Portions of the samples were submitted for full analytical after being treated with just enough solid sodium sulfite to kill the bromine remaining in solution.

After standing at room temperature for about 6 hours, solids were observed and the solution was filtered. Additional solids were observed to have formed after standing for a total of about 16 hours and the solution was filtered again.

In Sample No. 5-2, 866 g of the HBr sample was charged to the apparatus. The mixture was heated to about 60° C. and about 26 g of Cl₂ was added over about 15 minutes. The experiment was stopped at 30 minutes of hold time and the mixture was filtered while still hot. The solution was allowed to stand at room temp overnight and filtered again. The final solution was sampled for analysis.

In Sample No. 5-3, 878 g of the HBr sample was charged to the apparatus. The mixture was heated to about 80° C. and about 26 g of Cl₂ was added over about 15 minutes. The experiment was stopped at 30 minutes of hold time and the mixture was filtered while still hot. The solution was allowed to stand at room temp overnight and filtered again. The final solution was sampled for analysis.

In Sample No. 5-4, 878 g of the HBr sample was charged to the apparatus. The mixture was heated to about 100° C. and about 26 g of Cl₂ was added over about 15 minutes. The reaction temperature dropped to about 96° C. during the addition. The experiment was stopped at 30 minutes of hold time and the mixture was filtered while still hot. The solution was allowed to stand at room temp overnight and filtered again. The final solution was also sampled for analysis. The hot filtration resulted in no solids isolated. Solids were observed to crystalize as the solution cooled.

In Sample No. 5-5, 874 g of the HBr sample was charged to the apparatus. The mixture was heated to about 80° C. Excess bromine was added subsurface until the solution was saturated. The experiment was stopped at 30 minutes of hold time and the mixture was filtered while still hot. The solution allowed to stand at room temp overnight but was not filtered again after standing overnight due to only a very small amount of solids having formed. It would appear as though the bromine only method results in solids that are less soluble than generated by the chlorination route.

TABLE 3

| Sample No.- | 5-0 | 5-1A | 5-1B | 5-1C | 5-2A | 5-2B | 5-3A | 5-3B | 5-4A | 5-4B | 5-5 |
|---|---|---|---|---|---|---|---|---|---|---|---|
| Conditions of | Filtered | 15 min | 30 min | 16 h | 30 min | 16 h | 30 min | 16 h | 30 min | 16 h | 30 min |
| Filtration | and well | at | at | at | at | at | at | at | at | at | at |
| | mixed | 40° C. | 40° C. | 25° C. | 60° C. | 25° C. | 80° C. | 25° C. | 100° C. | 25° C. | 80° C. |
| Halogen | — | Cl2 | Cl2 | Cl2 | Cl2 | Cl2 | Cl2 | Cl2 | Cl2 | Cl2 | Br2 |
| Temp of | — | 40 | 40 | 40 | 60 | 60 | 80 | 80 | 100 | 100 | 80 |
| Experiment | | | | | | | | | | | |
| Wt % HBr | 9.24 | 14.12% | 13.29% | — | — | — | — | — | — | — | — |
| Wt % Free Br2 | 0 | — | — | 4.18 | — | 2.89 | — | 1.8 | — | 0.09 | — |
| Wt % Br— | 9.29 | 8.11% | 7.88% | — | — | — | — | — | — | — | — |
| Wt % Cl— | 0 | 2.82% | 2.91% | — | — | — | — | — | — | — | — |
| Phenol (ppm) | 0 | 0 | 0 | 0 | — | 1 | — | 0 | — | 0 | 1 |
| Br1Phenol (ppm) | 0 | 0 | 0 | 0 | — | 0 | — | 0 | — | 0 | 0 |
| Br2Phenol (ppm) | 0 | 19 | 8 | 0 | — | 0 | — | 0 | — | 0 | 0 |
| Tribromophenol | 9.6 | 7 | 18 | 11 | — | 14 | — | 11 | — | 13 | 19 |
| (ppm) | | | | | | | | | | | |
| TBBPA (ppm) | 0 | 14 | 0 | 0 | — | 0 | — | 0 | — | 0 | 0 |
| Unknown | 223.4 | 101 | 92 | 44 | — | 39 | — | 38 | — | 46 | 59 |
| Phenolics (ppm) | | | | | | | | | | | |
| Total | 233 | 141 | 119 | 55 | — | 54 | — | 49 | — | 59 | 79 |
| Phenolics | | | | | | | | | | | |
| (ppm) | | | | | | | | | | | |
| Incremental | — | 0 | 0.0061 | 0.0120 | 0.0674 | 0.0095 | 0.0683 | 0.0087 | 0 | 0.0467 | 0.0895 |
| Solids (g | | | | | | | | | | | |
| isolated/kg | | | | | | | | | | | |
| starting | | | | | | | | | | | |
| solition) | | | | | | | | | | | |
| Total Solids (g | — | 0 | 0.0061 | 0.0182 | 0.0674 | 0.0769 | 0.0683 | 0.0770 | 0 | 0.0467 | 0.0895 |
| isolated/kg | | | | | | | | | | | |
| starting | | | | | | | | | | | |
| solition) | | | | | | | | | | | |

### Example 6

An approximately 8% HBr solution was filtered and analyzed as Sample 6-0. To three 400 g gram solutions of this 8% HBr solution was added 0.53 g, 0.843 g, and 1.652 g of granular activated carbon (Norit GAC 1240), and the solutions stirred for 4 hours at room temperature. All four samples were filtered with a 0.45 micron Whatman Autovial syringeless filter to remove the carbon fines, and analyzed. The data is reported in Table 4.

TABLE 4

Sample No.

| | 1 | 2 | 3 | 4 |
|---|---|---|---|---|
| Mass solution | 400 | 400 | 400 | 400 |
| (grams) | | | | |
| Mass GAC (grams) | 0 | 0.53 | 0.843 | 1.652 |
| Time | 0 | 240 | 240 | 240 |
| Phenol (ppm) | 12 | 7 | 5 | 1 |
| Monobromophenol | 14 | 6 | 2 | 0 |
| (ppm) | | | | |
| Dibromophenol | 2 | 0 | 0 | 0 |
| (ppm) | | | | |
| Tribromophenol | 24 | 19 | 12 | 0 |
| (ppm) | | | | |
| TBBPA (ppm) | 0 | 0 | 0 | 0 |
| Unknown Phenolics | 360 | 165 | 44 | 5 |
| Total Phenolics | 384 | 198 | 64 | 5 |
| (ppm) | | | | |

### Example 7

A 50 mm ID column was charged with 139.3 g of granular activated carbon (Norit GAC 1240) to give a bed volume of about 280 mL. An HBr solution containing phenolics was pumped through the bottom of the column in an up feed manner at 5 mL/min. Thus the residence time was just under 1 hour. Samples were collected starting at 1 hour of feed time. Multiple samples were analyzed for APHA color while a single sample taken at about 2.5 hours was fully analyzed (Sample 7-1). The data for the APHA color data is provided in Table 5 and analysis of the starting material and sample taken at 2.5 hours in Table 6.

TABLE 5

| Time (hours) | APHA Color |
|---|---|
| 1.5 | 0 |
| 1.75 | 5 |
| 2.25 | 1.5 |
| 2.5 | 2 |
| 3 | 2 |

TABLE 6

| | 7-0 | 7-1 |
|---|---|---|
| Br-wt % | 9.47 | 9.46 |
| Cl-wt % | 0.26 | 0.32 |
| Phenol (ppm) | 0 | 0 |
| Monobromophenol | 0 | 0 |
| (ppm) | | |
| Dibromophenol | 0 | 0 |
| (ppm) | | |
| Tribromophenol | 14 | 0 |
| (ppm) | | |
| TBBPA (ppm) | 48 | 0 |
| Unknown Phenolics | 162 | 7 |
| Total Phenolics | 224 | 7 |
| (ppm) | | |
| APHA as is | 500 | 1 |

### Example 7

An 11 mm diameter jacketed column was loaded with 15 g of a styrenic adsorbent resin. A circulator with water was used to maintain a temperature of 60° C. An HBr solution with phenolics previously reacted with bromine, flash cooled, and then filtered was next sent down through the adsorbent bed via a peristaltic pump at a controlled rate. The starting concentration of phenolics in the HBr is reported as well as the concentration of the phenolics in the total volume of the HBr passed through the column. The phenolics concentration is determined by HPLC analysis. The data is reported in Table 7.

TABLE 7

| | Trials with a styrenic | | | | |
|---|---|---|---|---|---|
| | resin in a jacketed column | | | | |
| | Cycle | | | | |
| | 1 | 2 | 3 | 4 | 5 |
| Flow rate (mL/min) | 2.5 | 3.9 | 2.1 | 4.3 | 3.1 |
| Temp (C.) | 60 | 60 | 60 | 60 | 60 |
| Cycle time (min) | 1515 | 1042 | 1016 | 483 | 995 |
| Initial phenolics (ppm) | 429 | 429 | 166 | 166 | 80 |
| Phenolics at end(ppm) | 82 | 107.2 | 0 | 16 | 0 |

### EMBODIMENTS

Additionally or alternately, the disclosure can include one or more of the following embodiments.

Embodiment 1. A process for purifying an HX stream containing a phenolic residue, comprising treating the HX stream by oxidative halogenation to halogenate the phenolic residue, producing a halogenated phenolic residue and a halogenated solution; cooling the halogenated solution; and filtering the halogenated phenolic residue from the halogenated solution to produce a partially purified HX stream.

Embodiment 2. A process for purifying an HX stream containing a phenolic residue, comprising treating the HX stream by oxidative halogenation to halogenate the phenolic residue, producing a halogenated phenolic residue and a halogenated solution; cooling the halogenated solution; filtering the halogenated phenolic residue from the halogenated solution to produce a partially purified HX stream; and passing the partially purified HX stream across an adsorbent bed, producing a purified HX stream. The adsornbent bed comprise a carbon or polystyrene bed.

Embodiment 3. A process for purifying an HBr stream containing about 1 wt % or less phenolic residue, where the HBr stream of about 15 wt % HBr or less is treated with bromine as the halogen at greater than 60° C. to brominate the phenolic residue and produce a halogenated solution. The halogenated solution can be cooled to less than 60° C. and filtered to produce a partially purified HBr stream. The partially purified HBr stream can be further processed by passing it across an adsorbent bed.

Embodiment 4. The processes of one of the previous embodiments, wherein the oxidative halogenation is conducted at or above about 60° C.; at or above 80° C., or at or above 90° C.

Embodiment 5. The processes of one of the previous embodiments, wherein the reaction is cooled to at least about 20° C. below the halogenation temperature. The reaction can be cooled to about 60° C. or less. The reaction can be cooled to about 40° C. or less.

Embodiment 6. The processes of one of the previous embodiments, wherein the ratio of halogen to phenolic residue is about 2:1 to 20:1 weight/weight. The ratio of halogen to phenolic residue can be about 8:1 to 12:1 weight/weight.

Embodiment 7. The processes of one of the previous embodiments, wherein the HX stream contains less than about 5 wt % phenolic residue, less than about 3 wt %, or less than about 1 wt %.

Embodiment 8. The processes of one of the previous embodiments, wherein the HX stream is less than about 30 wt % HX, less than about 20 wt % HX, less than about 15 wt % HX, or less than about 12 wt % HX.

Embodiment 9. The processes of one of the previous embodiments, wherein the HX stream, the partially purified HX stream, and the purified HX stream each comprises HBr.

Embodiment 10. The processes of one of the previous embodiments, wherein the oxidative halogenation is oxidative bromination, and the halogen in bromine.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based can be readily utilized as a basis for the design of other structures, methods, and systems for carrying out the several purposes of the embodiments and claims presented in this application. It is important, therefore, that the claims be regarded as including such equivalent constructions.

We claim:

1. A process for purifying an HX stream containing a phenolic residue, comprising
Treating the HX stream by oxidative halogenation to halogenate the phenolic residue, producing a halogenated phenolic residue and a halogenated solution;
Cooling the halogenated solution; and
Filtering the halogenated phenolic residue from the halogenated solution to produce a partially purified HX stream;
wherein the HX stream comprises an HCl stream, an HBr stream, an HI stream, or combinations thereof.

2. The process of claim 1, further including passing the partially purified HX stream across an adsorbent bed, producing a purified HX stream.

3. The process of any of claims 1-2, wherein the HX stream contains less than about 5 wt % phenolic residue.

4. The process of any of claims 1-2, wherein the HX stream contains less than about 1 wt % phenolic residue

5. The process of any of claims 1-4, wherein the HX stream is less than about 30 wt % HX.

6. The process of any of claims 1-4, wherein the HX stream is less than about 15 wt % HX.

7. The process of any of claim 1-6, wherein the HX stream, the partially purified HX stream, and the purified HX stream each comprises HBr.

8. The process of any of claims 1-7 wherein the oxidative halogenation is oxidative bromination, and the halogen in bromine.

9. The process of any of claims 1-8, wherein the oxidative halogenation is conducted at or above about 60° C.

10. The process of any of claims 1-8, wherein the oxidative halogenation is conducted at or above about 90° C.

11. The process of any of claims 1-10, wherein the reaction is cooled to at least about 20° C. below the halogenation temperature.

12. The process of any of claims 1-10, wherein the reaction is cooled to about 60° C. or less.

13. The process of any of claims 1-10, wherein the reaction is cooled to about 40° C. or less.

14. The process of any of claims 1-13, wherein the ratio of halogen to phenolic residue is about 2:1 to 20:1 weight/weight.

15. The process of any of claims 1-13, wherein the ratio of halogen to phenolic residue is about 8:1 to 12:1 weight/weight.

16. The process of any of claims 2-15, where the adsorbent bed comprises a carbon or polystyrene bed.
